(19) United States
(12) Patent Application Publication
(10) Pub. No.: US 2026/0204998 A1
(43) Pub. Date: Jul. 16, 2026

(54) POWER CONVERSION SYSTEM

(71) Applicant: TOYOTA JIDOSHA KABUSHIKI KAISHA, Toyota-shi (JP)

(72) Inventor: Yuu KAWAI, Susono-shi (JP)

(73) Assignee: TOYOTA JIDOSHA KABUSHIKI KAISHA, Toyota-shi (JP)

(21) Appl. No.: 19/407,539

(22) Filed: Dec. 3, 2025

(30) Foreign Application Priority Data
Jan. 14, 2025 (JP) 2025-004953

(51) Int. Cl. H02M 1/00; H02M 1/32

(52) U.S. Cl. CPC H02M 1/0009; H02M 1/0025; H02M 1/0083; H02M 1/32

(57) ABSTRACT

The power conversion system includes: a power converter that converts DC power into AC power; an AC end to which AC power from the power converter is supplied via a LC filter; a switch provided between the AC end and the AC supply path; a voltage detection unit that detects a voltage at the AC end; a current detection unit that detects a current at the AC end; a virtual synchronous generator control unit that sets a frequency of a voltage at the AC end based on the effective power; an amplitude control unit that sets an amplitude of the voltage at the AC end; a voltage command unit that generates a voltage command value at the AC end based on the frequency of the voltage at the AC end; and a current limiting unit that corrects the voltage command value so that the current at the AC end decreases.

### CROSS-REFERENCE TO RELATED APPLICATION

This application claims priority to Japanese Patent Application No. 2025-004953 filed on Jan. 14, 2025. The disclosure of the above-identified application, including the specification, drawings, and claims, is incorporated by reference herein in its entirety.

### BACKGROUND

### 1. Technical Field

The present disclosure relates to a power conversion system that converts direct-current (DC) power into alternating-current (AC) power and outputs the AC power.

### 2. Description of Related Art

Conventionally, there has been known a voltage control inverter that can be connected to a power system via a switch (main contactor) (see Japanese Unexamined Patent Application Publication No. 2022-142483 (JP 2022-142483 A), for example). When connecting the voltage control inverter to the power system, a switch is closed in advance, and a system voltage is detected by a voltage sensor installed on the power system side with respect to the switch in a state in which the voltage control inverter is gate-blocked. Further, the frequency and the phase of the output voltage of the voltage control inverter are set based on the detected system voltage, and after the gate block of the voltage control inverter is canceled, the frequency of the output voltage is changed to a system frequency in a slope manner (gently).

### SUMMARY

As described above, after the gate block is canceled, the frequency of the output voltage of the voltage control inverter is changed to the system frequency in a slope manner. Accordingly, the voltage control inverter can be connected to the power system while suppressing the occurrence of an overcurrent in the power system. However, the power sharing of the voltage control inverter is limited while the frequency of the output voltage of the voltage control inverter is changed to the system frequency in a slope manner.

In view of the above, it is a main object of the present disclosure to suppress the power sharing of a power conversion system being limited while suppressing the occurrence of an overcurrent.

An aspect of the present disclosure provides a power conversion system including a power converter, an alternating-current (AC) end, a switch, a voltage detection unit, a current detection unit, a virtual synchronous generator control unit, an amplitude control unit, a voltage command unit, and a current limiting unit.

The power converter converts direct-current (DC) power into AC power.
The AC power from the power converter is supplied to the AC end via an LC filter.
The switch is provided between the AC end and an AC supply path.
The voltage detection unit detects a voltage of the AC end. The current detection unit detects a current of the AC end.
The virtual synchronous generator control unit sets a frequency of the voltage of the AC end based on effective power obtained from a detection value from the voltage detection unit and a detection value from the current detection unit.
The amplitude control unit sets an amplitude of the voltage of the AC end. The voltage command unit generates a voltage command value for the AC end based on the frequency and the amplitude of the voltage of the AC end.
The current limiting unit corrects the voltage command value such that the current of the AC end is reduced when an absolute value of the detection value from the current detection unit is equal to or more than a threshold value.
This makes it possible to suppress the occurrence of an overcurrent by correcting the voltage command value according to the detection value from the current detection unit.
Further, even when the voltage command value is corrected, the phase characteristics of the voltage command value can be maintained according to the frequency set by the virtual synchronous generator control unit, as long as the correction is executed within half the cycle of the frequency of the voltage of the AC end. As a result, it is possible to suppress the power sharing of the power conversion system being limited while suppressing the occurrence of an overcurrent.

When a different AC power supply system is connected to the AC supply path, the switch may be permitted to close after the threshold value of the current limiting unit is changed to a value that is less than a rated current of the different AC power supply system. The threshold value may be returned to a predetermined reference value as a predetermined return condition is satisfied after the switch is closed.

The power conversion system may further include

a governor control unit that sets a power adjustment amount for the effective power based on a frequency deviation calculated by the virtual synchronous generator control unit.
When a different AC power supply system is connected to the AC supply path, at least one of a characteristic value of the virtual synchronous generator control unit and a characteristic value of the governor control unit may be set to a value that is different from a characteristic of the different AC power supply system.

At least one of the characteristic value of the virtual synchronous generator control unit and the characteristic value of the governor control unit is set to a value that is different from the characteristic of the different AC power supply system during a period since before the switch is closed until a predetermined return condition is satisfied after the switch is closed.

The power conversion system may further include

a pulse control unit that generates a pulse signal for the power converter based on the detection value from the voltage detection unit and the voltage command value.
The pulse control unit may have a voltage waveform shaping function of attenuating a DC component generated in the detection value from the voltage detection unit. The pulse control unit may have a voltage waveform shaping function of attenuating a frequency component that is higher than a fundamental wave generated in the detection value from the voltage detection unit or a frequency component other than the fundamental wave.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing a power conversion system of the present disclosure;

FIG. 2 is a block diagram illustrating a virtual synchronous generator control unit and a governor control unit of the power conversion system of the present disclosure;

FIG. 3 is a flowchart illustrating a routine executed by a controller of the power conversion system of the present disclosure;

FIG. 4 is a flowchart illustrating a routine performed by a current limiting unit of the power conversion system of the present disclosure;

FIG. 5 is a time chart illustrating an example of a time variation of a voltage at an AC end and a current at an AC end when the routine of FIG. 4 is executed;

FIG. 6 is an enlarged time diagram of VI of FIG. 5;

FIG. 7 is a time chart showing another example of the time variation of the voltage at the AC end and the current at the AC end when the routine of FIG. 4 is executed;

FIG. 8 is a time chart showing still another example of the time variation of the voltage at the AC end and the current at the AC end when the routine of FIG. 4 is executed;

FIG. 9 is a time chart showing an enlarged IX portion of FIG. 8; and

FIG. 10 is a time chart showing another example of the time change of the voltage at the AC end and the current at the AC end when the routine of FIG. 4 is executed.

### DETAILED DESCRIPTION OF EMBODIMENTS

Embodiments of the present disclosure will now be described with reference to the drawings.

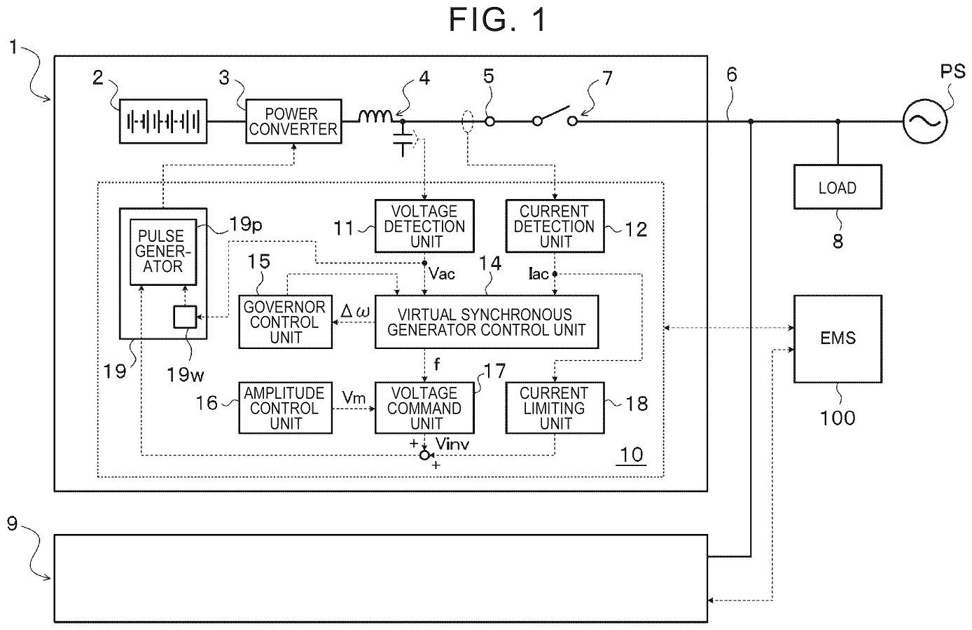

FIG. 1 is a schematic configuration diagram showing a power conversion system 1 of the present disclosure. The power conversion system 1 shown in the drawing includes a power storage device 2 capable of outputting DC power, and a power converter 3 that converts DC power from the power storage device 2 into AC power. The power conversion system 1 shown in the figure includes an AC end 5 to which AC power from the power converter 3 is supplied via LC filters 4, an AC supply path 6, an opening/closing switch 7 provided between the AC end 5 and the AC supply path 6, and a control device 10 on which a virtual synchronous generator control technique is implemented. The power storage device 2 may be an in-vehicle battery mounted on a battery electric vehicle (BEV) or a hybrid electric vehicle (HEV, PHEV). The power converter 3 may be a power control device (inverter) mounted on a battery electric vehicle or the like. Further, the power storage device 2 may be a reusable battery removed from the battery electric vehicle (BEV) or hybrid electric vehicle (HEV, PHEV). The power converter 3 may be a power conditioner (PCS) including inverter. LC filters 4 combine an inductor and a capacitor.

The AC supply path 6 is electrically connected to loads 8, other AC power supply systems 9, and the like, which are present in the power system PS, households, and the like, at all times or selectively (detachably). The power system PS supplies AC power, and may include, for example, a synchronous generator motor, or may include a power generation system that generates electric power by renewable energy generation such as wind power generation or solar power generation. The load 8 may be a resistive load, an inductive load, a capacitive load, a nonlinear load, or the like. In the present embodiment, the AC power supply system 9 is implemented with a virtual synchronous generator control technology, and a so-called microgrid can be constructed together with the power conversion system 1. The AC power supply system 9 may have the same specifications as those of the power conversion system 1, or may have different specifications from those of the power conversion system 1. Needless to say, a plurality of AC power supply systems 9 can be connected to the AC supply path 6, and the AC power supply system 9 may be an AC power supply facility including a synchronous generator motor.

The control device 10 of the power conversion system 1 includes a computer having a CPU, ROM, RAM, an input/output interface, and the like, various drive circuitry, various logic IC, and the like, and controls the power converter 3, the opening/closing switch 7, and the like. In addition, the control device 10 is connected to an energy-management device (hereinafter referred to as “EMS”) 100 via wired communication or wireless communication. EMS 100 includes at least one server (computer). EMS 100 transmits a command signal or the like to a control device (not shown) of the control device 10 or the AC power supply system 9 in accordance with the power supply state of the power system PS and the demand state of the power, and acquires various kinds of information from the control device 10 or the AC power supply system 9.

As illustrated in FIG. 1, in the control device 10, a voltage detection unit 11, a current detection unit 12, a virtual synchronous generator control unit 14, a governor control unit 15, an amplitude control unit 16, a voltage command unit 17, a current limiting unit 18, and a pulse control unit 19 are constructed as functional blocks by cooperation of hardware such as a CPU and a plurality of programs installed in a ROM. The voltage detection unit 11 of the control device 10 detects the voltage between the terminals of the capacitors of LC filters 4, that is, the voltage (instantaneous value) Vac of the AC power supplied from the power converter 3 to the AC end 5. The current detection unit 12 detects the current flowing through the inductor of LC filter 4, that is, the current (instantaneous value) Iac of the AC power supplied from the power converter 3 to the AC end 5. Note that the current supplied to the AC end 5 via LC filters 4 may be detected as a current (instantaneous value) Iac.

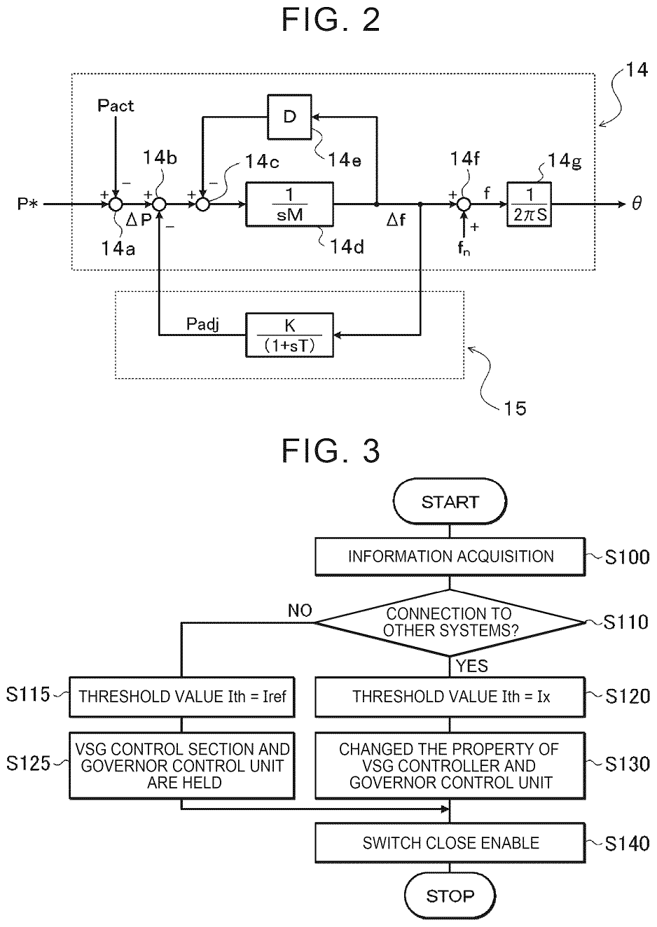

As illustrated in FIG. 2, the virtual synchronous generator control unit 14 includes a subtractor 14a, 14b, 14c, an integrator 14d, a multiplier 14e, an adder 14f, and an integrator 14g. The frequency f (target frequency) of the voltage supplied from the power converter 3 to the AC end 5 is set. The subtractor 14a subtracts the active power Pact calculated based on the voltage Vac detected by the voltage detection unit 11 and the current Iac detected by the current detection unit 12 from the power command value P* from EMS 100, and outputs the obtained power deviation ΔP to the subtractor 14b. The subtractor 14b subtracts the power adjustment quantity Padj set by the governor control unit 15 from the power deviation ΔP, and outputs the adjusted power deviation ΔP−Padj to the subtractor 14c. The subtractor 14c subtracts the output value of the multiplier 14e from the power deviation ΔP−Padj, and outputs the obtained difference value to the integrator 14d. Note that the power command value P* is not limited to being transmitted from EMS 100, and may be a predetermined value.

The integrator 14d divides the difference value from the subtractor 14c by the inertia constant M, integrates the obtained quotient value, derives a frequency deviation Δf, and outputs the frequency deviation Δf to the multiplier 14e, the adder 14f, and the governor control unit 15. The inertia constant M indicates the magnitude of the inertial force provided by the power conversion system 1. The multiplier 14e multiplies the frequency deviation Δf from the integrator 14d by the braking constant D, and outputs (feeds back) the obtained integrated value to the subtractor 14c. The adder 14f outputs the sum of the frequency deviation Δf from the integrator 14d and the rated frequency fn in the predetermined power conversion system 1 (power converter 3) to the integrator 14g as a frequency f. The integrator 14g outputs the phase angle θ obtained by integrating the product of the frequencies f and 2π from the adder 14f to the voltage command unit 17.

The governor control unit 15 performs the operation of the governor in the synchronous generator in a pseudo manner, and is provided for the purpose of reducing the frequency deviation Δf without significantly impairing the characteristics of the inertial force simulated by the virtual synchronous generator control unit 14. As shown in FIG. 2, the governor control unit 15 multiplies the frequency deviation Δf output from the virtual synchronous generator control unit 14 (integrator 14d) by the transfer function {K/(1+sT)}, and outputs the obtained product value as the power adjusting amount Padj to the subtractor 14b. However, “T” is the time constant of the governor according to the above purpose, and “K” is the gain of the governor according to the above purpose.

When the AC power is constantly supplied from the power converter 3 to the AC end 5, the frequency f set by the virtual synchronous generator control unit 14 is stabilized (converged), and the power command value P*, the active power Pact, and the power adjusting amount Padj by the governor control unit 15 are balanced. In such a situation, for example, when the power supply from the AC supply path 6 to the load 8 is started, the active power Pact increases, and the virtual synchronous generator control unit 14 decreases the frequency f in accordance with the increase in the active power Pact. In addition, the governor control unit 15 sets the power adjusting amount Padj so that the convergence value of the variation range of the frequency f becomes smaller. As a result, the frequency f can be changed in a synchronous generator based on the power deviation ΔP between the power command value P* and the active power Pact at the time of transient such as when the power is supplied from the power converter 3 or when the power loads are abruptly changed, and a large steady-state deviation can be suppressed from remaining with respect to the reference frequency at the time of steady state after the transient change.

Amplitude control unit 16, a predetermined effective value (when a single-phase AC power is output to the AC end 5, for example, 200 V) or amplitude (√2 times the effective value, when a single-phase AC power is output to the AC end 5, for example, 282 V) is set to the amplitude Vm, and outputs the set amplitude Vm to the voltage command unit 17. However, the amplitude control unit 16 may set an amplitude Vm (command value) so that the difference between the predetermined effective value and the effective value of the voltage Vac detected by the voltage detection unit 11 is small, and may output the amplitude Vm to the voltage command unit 17. As shown in FIG. 1, the voltage command unit 17 sets a voltage command value Vinv, which is a target value of the voltage supplied to the AC end 5, based on the phase angle θ from the virtual synchronous generator control unit 14 and the amplitude Vm from the amplitude control unit 16. When the single-phase AC power is output to the AC end 5, it becomes Vinv=Vm·sinθ, and when the three-phase AC power is output to the AC end 5, Vinv=(Vm·sinθ, Vm·sin(θ−2·π/3), Vm·sin(θ−4·π/3).

The current limiting unit 18 sets a correcting amount to be added to the voltage command value Vinv outputted from the voltage command unit 17 based on the current Iac detected by the current detection unit 12. When the absolute value of the current Iac is equal to or less than the threshold value Ith, the current limiting unit 18 sets the correcting amount to zero. The threshold value Ith is basically set to a constant reference value Iref (positive value) which is set to be smaller than a limit value for protecting an overcurrent which is larger than a rated current which is a steady reference of the power converter 3. In addition, when the impedance in the AC supplying path 6 or the like is low, the current Iac may constantly exceed the rated current of the power converter 3. Therefore, the current limiting unit 18 sets the correcting amount of the voltage command value Vinv so that the current Iac (absolute value) decreases when the absolute value of the current Iac is equal to or larger than the threshold value Ith. Note that the current limiting unit 18 may be configured such that, at the beginning of supplying power from the power converter 3, or when the current Iac continuously exceeds a threshold value (a value less than the reference value Iref) of the amplitude based on the steady rated current, the current Iac changes the reference value Iref set to the threshold value Ith to a threshold value (a value less than the reference value Iref) of the amplitude based on the steady rated current in order to reduce the current Iac (absolute value).

As illustrated in FIG. 1, the pulse control unit 19 includes a pulse generation unit 19p and a voltage waveform shaping unit 19w. The pulse generation unit 19p generates a pulse signal to the power converter 3 by any one of pulse width modulation, pulse amplitude modulation, pulse density modulation, and the like, based on the voltage Vac detected by the voltage detection unit 11 and the voltage command Vinv to which the correction amount by the current limiting unit 18 is added. The voltage waveform shaping unit 19w extracts DC components of the voltage Vac from the voltage detection unit 11. The voltage waveform shaping unit 19w corrects the voltage command Vinv based on the extracted DC components. The voltage waveform shaping unit 19w extracts a frequency component higher than the fundamental wave generated in the voltage Vac from the voltage detection unit 11, and corrects the voltage command Vinv based on the extracted frequency component.

As a result, the DC component having a lower frequency than the fundamental wave and the frequency component having a higher frequency than the fundamental wave generated in the voltage Vac are attenuated. The attenuation of the DC component of the voltage Vac mitigates the DC polarization that occurs when the load 8 is an inductive load, and suppresses the lateral current caused by the difference in the DC component with the other AC power source 9. In addition, the attenuation of the frequency component higher than the fundamental wave improves the voltage-waveform distortion caused by the presence of the high-frequency component in the current Iac when the load 8 is a nonlinear load or the like, and suppresses the lateral flow caused by the difference in the high-frequency component with the other AC power supply system 9. That is, the voltage waveform shaping unit 19w suppresses the lateral flow that leads to the imbalance in the power sharing between the power conversion system 1 and the other AC power supply system 9, thereby improving the parallelism of the system. The voltage waveform shaping unit 19w may be configured to correct the voltage command Vinv based on frequency components other than the fundamental wave generated in the voltage Vac from the voltage detection unit 11.

Next, the operation of the power conversion system 1 will be described with reference to FIG. 3 to FIG. 6. FIG. 3 is a flowchart exemplifying a routine executed by the control device 10 when the control device 10 of the power conversion system 1 is requested to supply AC power from EMS 100 to the AC supply path 6.

At the beginning of the routine illustrated in FIG. 3, the control device 10 acquires information required for controlling the power converter 3 and the like, such as the state of connecting the other AC power supply system 9 to the AC supply path 6, the rated value (specifications) and the characteristic of the other AC power supply system 9 that can be connected to the AC supply path 6, and the like, from the EMS 100 (S100). The control device 10 determines whether or not another AC power supply device 9 is connected to the AC supply path 6 based on the acquired data (S110). When another AC power supply device 9 is not connected to the AC supply path 6 (S110: NO), the control device 10 sets the above-described reference value Iref to the threshold value Ith in the current limiting unit 18 (S115). Further, the control device 10 holds characteristic values such as the inertia constant M and the braking constant D that define the characteristics of the virtual synchronous generator control unit 14 and characteristic values such as the time constant T and the gain K that define the characteristics of the governor control unit 15 at predetermined reference values (S125).

When another AC power supply system 9 is connected to the AC supply path 6 (S110: YES), the control device 10 sets a value Ix (positive value) that differs from the above-described reference value Iref to the threshold value Ith in the current limiting unit 18 based on the rated value of the other AC power supply system 9 acquired by S100 (S120). In S120, the control device 10 sets the value Ix to the threshold value Ith after setting it to be smaller than the rated current Irat and the reference value Iref of the other AC power supply device 9 acquired by S100 in accordance with a predetermined threshold value setting constraint. Further, when another AC power supply system 9 is connected to the AC supply path 6 (S110: YES), the control device 10 sets (changes) the characteristic values such as the inertia constant M and the braking constant D that define the characteristics of the virtual synchronous generator control unit 14 and the characteristic values such as the time constant T and the gain K that define the characteristics of the governor control unit 15 to values that differ from the characteristics of the other AC power supply system 9 in accordance with predetermined characteristic setting constraints (S130). Note that, in a case where S100 cannot acquire the status of connecting the other systems as in the case where EMS 100 does not exist, an affirmative determination may be uniformly made in S110.

After S125 or S130 process, the control device 10 permits the opening/closing switch 7 to be closed (S140) and terminates the routine of FIG. 3. Thus, in the power conversion system 1, when the other AC power supply system 9 is connected to the AC supply path 6, prior to closing of the opening/closing switch 7, the threshold value Ith in the current limiting unit 18, the characteristics value of the virtual synchronous generator control unit 14, and the characteristics value of the governor control unit 15 is changed to a value different from the ratings value and characteristics of the other AC power supply system 9 (S120, S130), the opening/closing switch 7 after the change of the threshold value Ith or the like will be closed.

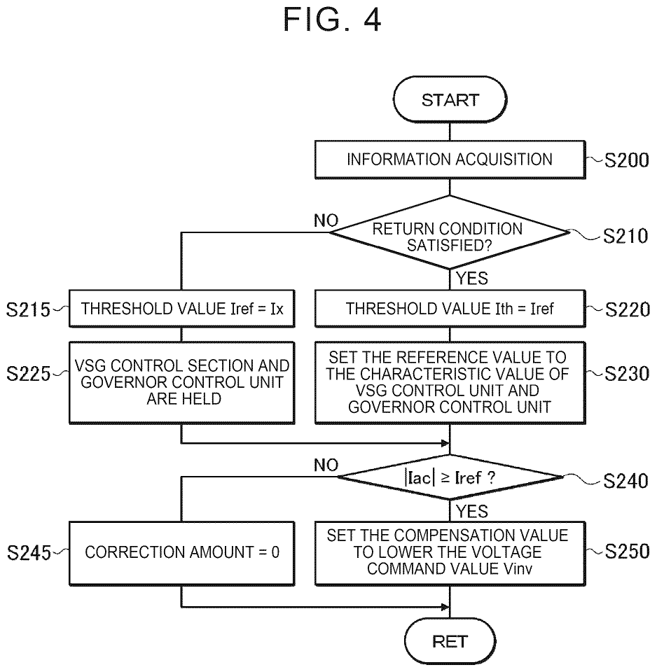

FIG. 4 is a flowchart illustrating a routine that is repeatedly executed by the current limiting unit 18 of the control device 10 every predetermined time (minute time) while the opening/closing switch 7 of the power conversion system 1 is closed and power is supplied from the power converter 3 to the AC supply path 6.

When the timing of executing the routine of FIG. 4 arrives, the current limiting unit 18 acquires the required information such as the current Iac detected by the current detection unit 12 and the frequency of the AC power supplied to the AC end 5 from the power converter 3 separately calculated (acquired) (S200). Next, the current limiting unit 18 determines whether or not a predetermined return condition is satisfied based on the information acquired by S200 (S210). In the present embodiment, S210 is performed when a predetermined period of time has elapsed while a difference from the previous value of the frequency acquired by S200 is less than or equal to a predetermined value. However, the return condition in S210 may be satisfied when a predetermined period of time has elapsed since the opening/closing switch 7 is closed.

When it is determined that the return condition is not satisfied (S200: NO), the current limiting unit 18 holds the threshold value Ith in the current limiting unit 18 in the value Ix set in the routine of FIG. 2 (S215). Further, the current limiting unit 18 transmits a command signal to the virtual synchronous generator control unit 14 and the governor control unit 15 so as to hold the characteristic values such as the inertia constant M and the braking constant D of the virtual synchronous generator control unit 14 and the characteristic values such as the time constant T and the gain K of the governor control unit 15 at the values set in the routine of FIG. 2 (S225).

When it is determined that the return condition is satisfied (S200: YES), the current limiting unit 18 sets the above-described reference value Iref to the threshold value Ith in the current limiting unit 18 (S220). Further, the current limiting unit 18 transmits a command signal to the virtual synchronous generator control unit 14 and the governor control unit 15 so as to set a predetermined reference value for each of the characteristic values such as the inertia constant M and the braking constant D that define the characteristics of the virtual synchronous generator control unit 14 and the characteristic values such as the time constant T and the gain K that define the characteristics of the governor control unit 15 (S230).

After S225 or S230 process, the control device 10 determines whether or not the absolute value of the current Iac acquired by S200 is equal to or greater than the threshold value Ith set by S115 or S120 (S240). When the absolute value of the current Iac is less than the threshold value Ith (S240: NO), the current limiting unit 18 sets zero to the correction amount added to the voltage command value Vinv (S245), and ends the routine of FIG. 4 once. On the other hand, when the absolute value of the current Iac is equal to or larger than the threshold value Ith (S240: YES), the current limiting unit 18 sets the correcting amount of the voltage command value Vinv set by the voltage command unit 17 so as to reduce the absolute value of the current Iac (S250), and ends the routine of FIG. 4 once. The corrected amount of the voltage command value Vinv may be generated by using a PI controller or the like so as to gradually reduce the absolute value of the current Iac.

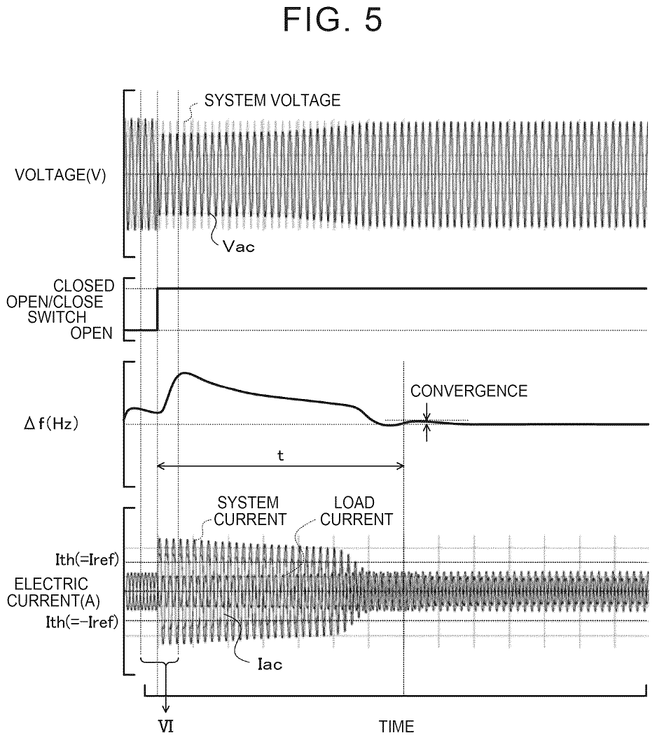

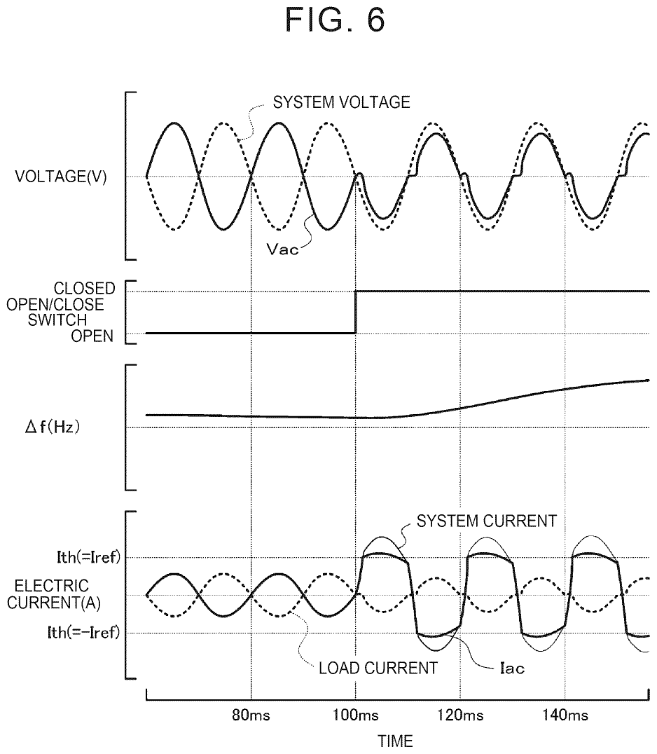

FIG. 5 is a time chart showing temporal changes such as voltage Vac and current Iac when, for example, the routine of FIG. 4 is executed when power is supplied from the power system PS to the AC supply path 6, the other AC power supply system 9 is not connected to the AC supply path 6, the load 8 is a resistive load, and the power command value P* is 50% of the rated power of the power converter 3. FIG. 6 is an enlarged time diagram of VI unit of FIG. 5. As shown in FIG. 6, when the opening/closing switch 7 is closed at a timing when the voltage phase of the voltage Vac is inverted with respect to the voltage phase of the power system PS, the current Iac increases due to the potential difference caused by the asynchronous phase. Here, when the absolute value of the current Iac becomes equal to or larger than the threshold value Ith (=Iref) after the opening/closing switch 7 is closed, the current of the load 8 and the voltage Vac of the AC power supplied from the power converter 3 to the AC end 5 are adjusted in accordance with the correction amount set by the current limiting unit 18 so that the potential difference accompanying the asynchronous phase becomes small. As a result, the generation of a current exceeding the threshold value Ith, i.e., an overcurrent, can be suppressed by correcting the voltage command value Vinv according to the detection value (current Iac) of the current detection unit 12. Further, even when the voltage command value Vinv is corrected when the absolute value of the current Iac is equal to or larger than the threshold value Ith, the phase characteristic of the voltage command value Vinv can be maintained in accordance with the frequency f set by the virtual synchronous generator control unit 14, as long as the correction execution period is within the half cycle of the frequency of the voltage Vac of the AC end 5. The area of −Iref≤Iac≤Iref in FIG. 6 is so small that the corrections set by the current limiting unit 18 are negligible.

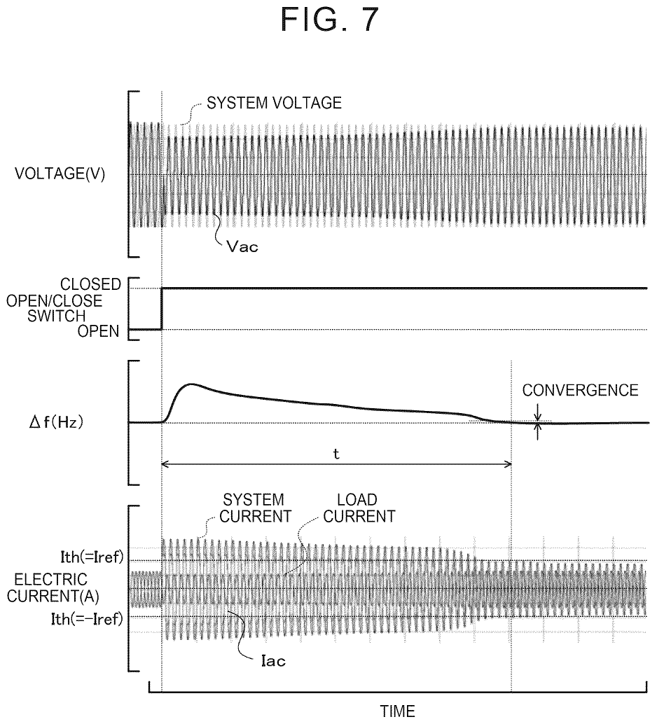

Then, according to the analysis (simulation) of the present inventor, in the example of FIG. 5, it has been found that the frequency of the voltage Vac of the AC end 5 converges at t≈0.7 seconds after the opening/closing switch 7 is closed at a timing when the voltage phase of the voltage Vac is inverted with respect to the voltage phase of the power system PS. Further, FIG. 7 is a time chart showing temporal changes such as voltage Vac and current Iac when power is supplied from the power system PS to the AC supply path 6, the other AC power supply system 9 is not connected to the AC supply path 6, the load 8 is not present, and the power command value P* is zero, or the power is supplied from the power system PS to the AC supply path 6, the other AC power supply system 9 is not connected to the AC supply path 6, the load 8 is a resistive load, and the power command value P* is zero, and the routine of FIG. 4 is executed. According to the analysis of the present inventor, in the embodiment of FIG. 7, it has been found that the frequency of the voltage Vac of the AC end 5 converges at t≈1.0 seconds after the opening/closing switch 7 is closed at a timing at which the voltage phase of the power system PS and the voltage phase of the voltage Vac are inverted.

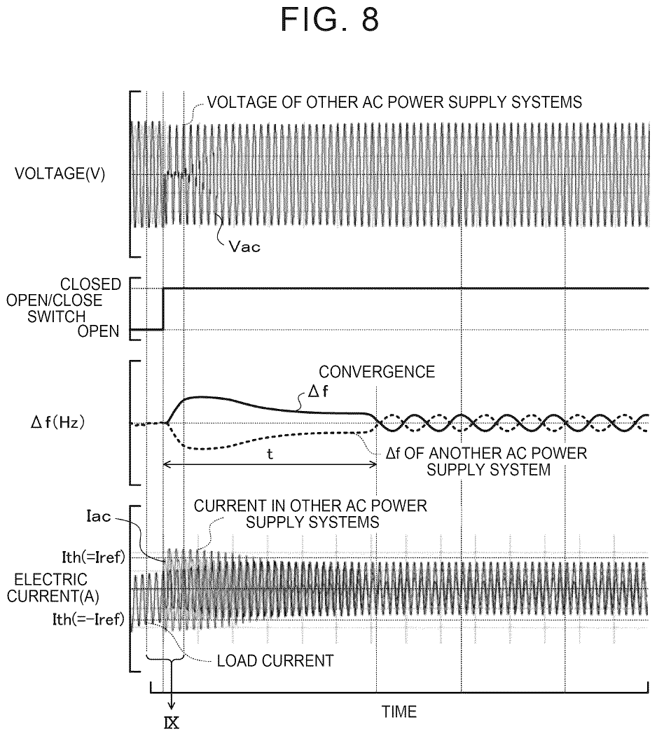

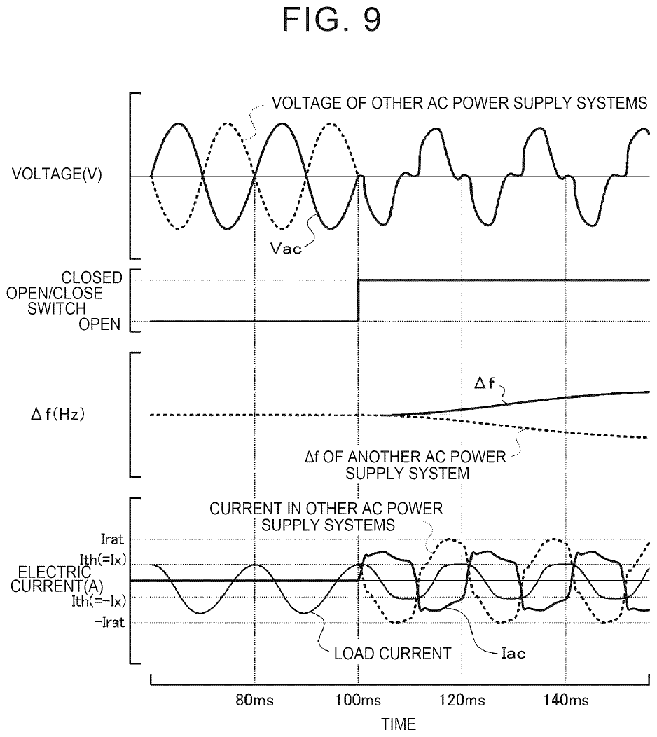

Further, FIG. 6 is a time chart showing temporal changes in voltage Vac, current Iac, and the like when the routine of FIG. 4 is executed in a state where, for example, power is not supplied from the power system PS to the AC supply path 6, the other AC power supply system 9 supplies AC power to the AC supply path 6 prior to the power conversion system 1, and the load 8 is an inductive load. FIG. 9 is an enlarged time diagram of IX unit of FIG. 8. In the embodiment of FIG. 9, the threshold value Ith of the current limiting unit 18 is set to a value Ix smaller than the rated current Irat of the other AC power supply systems 9. As shown in FIG. 9, when the absolute value of the current Iac becomes equal to or larger than the threshold value Ith (=Ix) after the opening/closing switch 7 is closed, the current of the load 8 and the voltage Vac of the AC power supplied from the power converter 3 to the AC end 5 are adjusted in accordance with the correction amount set by the current limiting unit 18 so that the potential difference associated with the asynchronous phase becomes small. As a result, the generation of a current exceeding the threshold value Ith, i.e., an overcurrent, can be suppressed by correcting the voltage command value Vinv according to the detection value (current Iac) of the current detection unit 12. Further, even when the voltage command value Vinv is corrected when the absolute value of the current Iac is equal to or larger than the threshold value Ith, the phase characteristic of the voltage command value Vinv can be maintained in accordance with the frequency f set by the virtual synchronous generator control unit 14, as long as the correction execution period is within the half cycle of the frequency of the voltage Vac of the AC end 5. The area of −Iref≤Iac≤Iref in FIG. 9 is so small that the corrections set by the current limiting unit 18 are negligible. According to the analysis (simulation) of the present inventor, in the example of FIG. 8, it has been found that the frequency of the voltage Vac of the AC end 5 converges at t≈0.6 seconds after the phase of the voltage Vac is reversed.

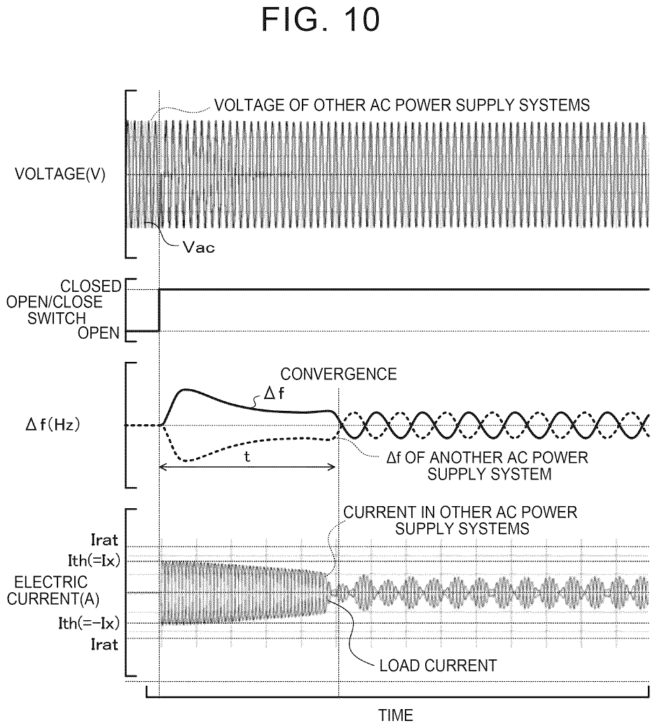

FIG. 10 is a time chart showing temporal changes such as voltage Vac and current Iac when the routine of FIG. 4 is executed, for example, when power is not supplied from the power system PS to the AC supply path 6, the other AC power supply system 9 supplies AC power to the AC supply path 6 prior to the power conversion system 1, and the load 8 is not present. According to the analysis of the present inventors, in the embodiment of FIG. 10, it has been found that the frequency of the voltage Vac of the AC end 5 converges at t≈0.5 seconds after the phase of the voltage Vac is reversed. In the analysis of the present inventor, the other AC power supply system 9 has the same characteristics as those of the virtual synchronous generator control unit 14 and the governor control unit 15 of the power conversion system 1, and the converged state in FIGS. 8 and 10 takes a sustained vibration state. Further, when the characteristics of the virtual synchronous generator control unit 14, the governor control unit 15, and the like are extremely different between the power conversion system 1 and the other AC power supply system 9, either one of the power conversion system 1 and the other AC power supply system 9 operates in the same manner as the power conversion system 1 shown in FIG. 5, and the other operates in the same manner as the power system PS shown in FIG. 5.

As described above, the power conversion system 1 includes the power storage device 2, the power converter 3, the AC end 5, the opening/closing switch 7, the voltage detection unit 11, the current detection unit 12, the virtual synchronous generator control unit 14, the amplitude control unit 16, the voltage command unit 17, and the current limiting unit 18. The power converter 3 converts DC power from the power storage device 2 into AC power. The AC power from the power converter 3 is supplied to the AC end 5 via LC filters 4. The opening/closing switch 7 is provided between the AC end 5 and the AC supply path 6. The voltage detection unit 11 detects the voltage Vac of the AC end 5. The current detection unit 12 detects the current Iac of the AC end 5. The virtual synchronous generator control unit 14 sets the frequency f of the voltage at the AC end 5 based on the active power Pact obtained from the detection values (Vac, Iac) of the voltage detection unit 11 and the current detection unit 12. The amplitude control unit 16 sets the amplitude Vm of the voltage of the AC end 5. The voltage command unit 17 generates the voltage command Vinv of the AC end 5 based on the frequency f and the amplitude Vm of the voltage of the AC end 5. Then, the current limiting unit 18 corrects the voltage command value Vinv so that the current Iac of the AC end 5 decreases (so that the absolute value decreases) when the absolute value of the detection value (Iac) of the current detection unit 12 is equal to or larger than the threshold value Ith (S240: YES, S250 in FIG. 4). Thus, the generation of the overcurrent can be suppressed by correcting (S250) the voltage command value Vinv according to the detection value (Iac) of the current detection unit 12. Further, even when the voltage command value Vinv is corrected, it is possible to maintain the phase characteristic of the voltage command value Vinv in accordance with the frequency f set by the virtual synchronous generator control unit 14, as long as the half cycle of the frequency of the voltage Vac of the AC end 5. As a result, it is possible to suppress the power sharing of the power conversion system 1 from being limited while suppressing the occurrence of an overcurrent.

Further, in the power conversion system 1, when another AC power supply system 9 is connected to the AC supply path 6 (S110: YES in FIG. 3), the closing of the opening/closing switch 7 is permitted after the threshold value Ith of the current limiting unit 18 is changed to a value Ix smaller than the rated current Irat of the other AC power supply system 9 (S140 in FIG. 3). Then, the threshold value Ith is returned to the predetermined reference value Iref in response to the predetermined return condition being satisfied after the opening/closing switch 7 is closed (S210: YES in FIG. 4). Thus, while the frequency of the AC power from the power conversion system 1 and the frequency of the AC power from the other AC power supply system 9 are not synchronized with each other and the phase of the AC power is shifted, the overcurrent is not generated in the power conversion system 1, and the total power (total voltage) of the AC power from the power conversion system 1 and the AC power from the other AC power supply system 9 can be suppressed from being significantly reduced.

Further, the power conversion system 1 includes a governor control unit 15 that sets a power command value P* (including P*=0) and a power adjusting amount Padj for the active power Pact based on the frequency deviation Δf calculated by the virtual synchronous generator control unit 14. When another AC power supply system 9 is connected to the AC supply path 6 (S110: YES in FIG. 3), the characteristic value of the virtual synchronous generator control unit 14 and the characteristic value of the governor control unit 15 are set to values that differ from the characteristics of the other AC power supply system 9 (S130 in FIG. 3). Thus, the current Iac output from the power conversion system 1 and the current output from the other AC power supply system 9 can be quickly balanced.

Further, in the power conversion system 1, the characteristic value of the virtual synchronous generator control unit 14 and the characteristic value of the governor control unit 15 are set to different values from the characteristics of the other AC power supply systems 9 from before the opening and closing of the opening/closing switch 7 until a predetermined return condition is satisfied after the closing of the opening/closing switch 7, but the present disclosure is not limited thereto. That is, in S130 of FIG. 3, only one of the characteristic value of the virtual synchronous generator control unit 14 and the characteristic value of the governor control unit 15 may be set (changed) to a value that differs from the characteristic of the other AC power supply system 9. The return condition for returning the characteristic value of the virtual synchronous generator control unit 14 and/or the governor control unit 15 to the reference value may differ from the return condition for returning the threshold value Ith of the current limiting unit 18 to the reference value Iref.

Further, the power conversion system 1 includes a pulse control unit 19 that generates a pulse signal to the power converter 3 based on the detection value (Vac) of the voltage detection unit 11 and the voltage command value Vinv. The pulse control unit 19 includes a voltage waveform shaping unit 19w (voltage waveform shaping function) that attenuates DC components occurring in a detection value (Vac) of the voltage detection unit 11. Accordingly, the gain in the low frequency range in the pulse generation unit 19p of the pulse control unit 19 can be reduced, and the power converter 3 can be controlled more appropriately.

In addition, the voltage waveform shaping unit 19w of the pulse control unit 19 attenuates frequency components higher than the fundamental wave generated in the detection value (Vac) of the voltage detection unit 11. As a result, it is possible to reduce the gain in the high-frequency range in the pulse generation unit 19p of the pulse control unit 19 and suppress the generation of distortion of the voltage-waveform due to the dead time of the power converter 3 and the harmonic components of the load current. Further, even when the voltage waveform shaping unit 19w is configured to attenuate frequency components other than the fundamental wave generated in the voltage Vac from the voltage detection unit 11, the same operation and effect can be obtained.

Note that the routine of FIG. 3 changes the threshold value Ith of the current limiting unit 18, the characteristic value of the virtual synchronous generator control unit 14, and the characteristic value of the governor control unit 15 to a value different from the characteristics of the other AC power supply system 9 in accordance with the connecting state of the other AC power supply system 9 with respect to the AC supply path 6 prior to the closing of the opening/closing switch 7, but the present disclosure is not limited thereto. That is, when the power conversion system 1 may constitute a microgrid together with at least one other AC power supply system 9, the routine of FIG. 3 may be modified to change at least any of the threshold value Ith in the current limiting unit 18, the characteristic value of the virtual synchronous generator control unit 14, and the characteristic value of the governor control unit 15 to a value that is different from the characteristics of the other AC power supply system 9, regardless of the state of connection of the other AC power supply system 9 to the AC supply path 6.

It is needless to say that the embodiment of the present disclosure is not limited to the above-described embodiments, and various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The embodiment of the present disclosure is applicable to a manufacturing industry of a power conversion system and the like.

What is claimed is:

1. A power conversion system comprising:
a power converter that converts direct-current (DC) power into alternating-current (AC) power;
an AC end to which the AC power from the power converter is supplied via an LC filter;
a switch provided between the AC end and an AC supply path;
a voltage detection unit that detects a voltage of the AC end;
a current detection unit that detects a current of the AC end;
a virtual synchronous generator control unit that sets a frequency of the voltage of the AC end based on effective power obtained from a detection value from the voltage detection unit and a detection value from the current detection unit;
an amplitude control unit that sets an amplitude of the voltage of the AC end;
a voltage command unit that generates a voltage command value for the AC end based on the frequency and the amplitude of the voltage of the AC end; and
a current limiting unit that corrects the voltage command value such that the current of the AC end is reduced when an absolute value of the detection value from the current detection unit is equal to or more than a threshold value.

2. The power conversion system according to claim 1, wherein when a different AC power supply system is connected to the AC supply path, the switch is permitted to close after the threshold value of the current limiting unit is changed to a value that is less than a rated current of the different AC power supply system, and the threshold value is returned to a predetermined reference value as a predetermined return condition is satisfied after the switch is closed.

3. The power conversion system according to claim 1, further comprising a governor control unit that sets a power adjustment amount for the effective power based on a frequency deviation calculated by the virtual synchronous generator control unit, wherein
when a different AC power supply system is connected to the AC supply path, at least one of a characteristic value of the virtual synchronous generator control unit and a characteristic value of the governor control unit is set to a value that is different from a characteristic of the different AC power supply system.

4. The power conversion system according to claim 3, wherein at least one of the characteristic value of the virtual synchronous generator control unit and the characteristic value of the governor control unit is set to a value that is different from the characteristic of the different AC power supply system during a period since before the switch is closed until a predetermined return condition is satisfied after the switch is closed.

5. The power conversion system according to claim 1, further comprising a pulse control unit that generates a pulse signal for the power converter based on the detection value from the voltage detection unit and the voltage command value, wherein
the pulse control unit has a voltage waveform shaping function of attenuating at least one of a DC component generated in the detection value from the voltage detection unit and a frequency component that is higher than a fundamental wave.
